(19) United States
(12) Patent Application Publication
(10) Pub. No.: US 2026/0044609 A1
(43) Pub. Date: Feb. 12, 2026

(54) Machine Learning-Based Approach to Characterize, Triage, and Remediate Software Supply Chain Risk

(71) Applicant: Binarly Inc, Santa Monica, CA (US)

(72) Inventors: Alexander Matrosov, Santa Monica, CA (US); Sam Lloyd Thomas, Birmingham (GB); Egor Vasilenko, Cambridge (GB)

(21) Appl. No.: 19/360,669

(22) Filed: Oct. 16, 2025

Related U.S. Application Data
(63) Continuation-in-part of application No. 18/639,784, filed on Apr. 18, 2024.
(60) Provisional application No. 63/632,486, filed on Apr. 10, 2024.

(51) Int. Cl. G06F 21/57

(52) U.S. Cl. CPC G06F 21/577; G06F 2221/033

(57) ABSTRACT

A software package is received and unpacked into multiple components comprising plural functions. Each function is lifted from machine code into static single-assignment intermediate representation and tokenized to produce semantics-preserving embeddings. Intermediate-representation data-flow features are extracted, including detection of constant static variables on a stack, stack reaching definitions, uninitialized variables, and intra-procedural aliases. For each component, the embeddings and features are input to a machine-learning model trained on semantic properties derived from a corpus of software packages to generate a software supply chain risk level. Data characterizing the risk level is provided to a consuming application. When the risk level satisfies a remediation criterion, a remediation action is initiated, including generation of a source-code patch recommendation for an identified root-cause function, insertion of a runtime guard into the component, or issuance of a security advisory for distribution to a security operations dashboard.

### RELATED APPLICATION

The current application claims priority to U.S. patent application Ser. No. 18/639,784 filed on Apr. 14, 2024 and U.S. Pat. App. Ser. No. 63/632,486 filed on Apr. 10, 2024, the contents of both of which are hereby fully incorporated by reference.

### TECHNICAL FIELD

The subject matter described herein is directed to machine learning techniques for detecting anomalous characteristics in components of software packages that may cause a computing system to behave undesirably, and for triaging those anomalies as part of a remediation process.

### BACKGROUND

Transforming human-readable source code into a machine-executable binary (e.g., a “binary” or an “executable”) can introduce security risks that are difficult to detect and assess. Malicious code may be surreptitiously injected into build pipelines-whether through a compromised compiler, toolchain component, or dependency-causing downstream systems to exhibit unintended or adversarial behavior. As modern software packages grow in complexity and rely on deeply nested interdependencies, the attack surface expands and the difficulty of identifying vulnerabilities increases. Moreover, compilation itself can introduce new weaknesses or negate security controls implemented at the source level, thereby compounding overall risk.

Vulnerabilities embedded in binaries are particularly acute at the firmware layer, which underpins and initializes higher-level software and hardware security controls. Compromised firmware can subvert trust anchors, disable or bypass protections enforced by operating systems and applications, and thereby undermine the effectiveness of subsequent security investments across the stack.

### SUMMARY

The current subject matter relates to machine-learning techniques for analyzing software packages at the level of executable machine code to detect, characterize, triage, and remediate risks in the software supply chain without requiring access to human-readable source code. The techniques emphasize semantics-preserving analysis so that results generalize across compilers, processor architectures, and optimization settings while maintaining fidelity to the original program behavior.

In various implementations, a received software package is unpacked into multiple components, each of which contains multiple functions. Components can include libraries, services, plug-ins, and other modules that expose well-defined interfaces. The unpacking and normalization steps prepare each component for analysis independently while retaining package-level context so that results can be aggregated.

Each function can be lifted from machine code into a static single-assignment intermediate representation. Prior to tokenization, identifier names, literal encodings, and symbol information can be normalized to reduce variance across compiler versions and optimization levels. The tokenized intermediate representation is then encoded by a trained semantics-preserving encoder to produce function-level vector representations that capture program meaning and enable robust comparison across builds and targets.

In parallel with semantic encoding, the system extracts intermediate-representation-derived data-flow features. These features can include detections of constant static variables allocated on the call stack, stack reaching definitions that indicate where variables are defined and overwritten, detections of uninitialized variables that may lead to undefined behavior, and indicators of aliases that occur within a single procedure. The system can also compute behavioral summaries such as patterns of stack access, counts of indirect function calls, and detections of opaque predicates and other suspicious control-flow constructs.

Characterization of risk at the level of individual components is performed by providing the function-level vector representations and the intermediate-representation-derived features to trained machine-learning models. In some implementations, an ensemble of models or a multi-class classifier produces category-specific software supply chain risk scores. Categories can include, by way of example, a vulnerability category, an open-source software control category related to risks introduced by version changes, a license category related to intellectual property compliance, a development category related to compatibility risks with a predefined codebase, and a supportability category related to the use of outdated or unsupported components.

The category-specific scores can be aggregated into an overall package-level score and stored together with analysis artifacts in a project repository keyed to the version of the software package. The repository can persist embeddings, intermediate-representation-derived features, and model outputs, enabling longitudinal tracking across versions and reproducible evaluations. Consuming applications can use these results to generate reports, populate dashboards, and update software bills of materials with component-level and package-level risk indicators.

In another implementation, the system computes an anomaly score for each component using a one-class detector trained on vector representations derived from components known to be trustworthy and compiled across different processor architectures and optimization settings. The anomaly detector operates over the space of function-level vector representations to identify components whose distribution deviates from known-good baselines. The models can incorporate attention-based pooling to weight functions by their contribution to a component's risk score and can compute explanatory indicators through density estimation in the space of vector representations, such as rare application programming interface usage, strings with high entropy, and unusual control-flow patterns.

The techniques further support identification of components and correlation with known vulnerabilities. Function-level vector representations generated from tokenized static single-assignment intermediate representation can be provided to a component-identification module that infers the identity of a component using similarity search over an index of vector representations and direct classification. Identification results can then be leveraged to query a vulnerability knowledge base or external service to retrieve known risks for the identified component, including affected versions and remediation guidance.

Outputs of component identification and category-specific risk scoring can be supplied to consuming applications to drive reporting, populate dashboards, update software bills of materials, and prioritize mitigations based on the criticality of dependencies within the package. These outputs can also feed governance, risk, and compliance processes to document decision rationales and remediation obligations at the level of individual components and transitive dependencies.

Upon detecting anomalous or vulnerable functionality, a triage workflow locates the corresponding locations in the original source code. To accomplish this, the system generates a first set of vector representations from source-code program representations, such as abstract syntax trees, control-flow graphs, program dependence graphs, and static single-assignment form, within a codebase index. These source-code vector representations are matched to the vector representations produced from intermediate-representation features of the analyzed executable so that function-level correspondences can be inferred.

Similarity between the two sets of vector representations can be computed using approximate nearest-neighbor search over an index structure designed for high-recall vector retrieval and calibrated to produce confidence scores. Confidence can be derived from similarity margins and auxiliary indicators such as constant pools, imported symbol names, string similarity, and control- and data-flow fingerprints. Where available, debug line mappings and build metadata can further strengthen provenance.

When the confidence satisfies a threshold, remediation actions can be initiated. Remediation can include synthesizing or recommending source-code patches at identified root-cause functions, inserting runtime guards, issuing security advisories with affected versions and indicators of exploitability, deprecating specific component versions, or applying configuration hardening policies. Candidate mitigations can be ranked by their expected impact based on risk levels and the criticality and privilege boundaries of the affected component. After remediation, verification can re-run classification on rebuilt packages to update risk scores and remediation status and to refresh software bill of materials entries with corrected provenance information.

When the confidence is insufficient, the system can defer remediation in favor of forensics focused on the software build pipeline and can flag potential tampering. Indicators can include dependency confusion, compromised build steps, or injected post-link artifacts. These cases can be escalated for supply-chain investigation and governed by policies that require additional evidence prior to change.

The disclosed techniques operate at both the component level and the package level and generalize across compilers, processor architectures, and optimization settings by using semantics-preserving vector representations learned from tokenized static single-assignment intermediate representations. The approach integrates risk scoring, component identification, triage, and remediation into a unified workflow that can be automated, audited end-to-end, and integrated with external reporting and governance systems.

In one implementation, a system includes processors and memory that collectively perform an end-to-end workflow to assess and address software supply-chain risk. The system receives a software package and decomposes it into components and their functions, lifts the functions into static single-assignment intermediate representation, and generates semantics-preserving embeddings from tokenized IR. From the same IR, the system computes data-flow features such as constant static variables on the stack, stack reaching definitions, uninitialized variables, and indicators of intra-procedural aliasing. Machine-learning models consume the embeddings and features to produce component-level risk scores and, in some cases, anomaly scores derived from a one-class detector. Using the embeddings, a component-identification module can infer component identity and query a vulnerability service for known issues. For triage, a source-code indexing subsystem generates embeddings from abstract syntax trees, control-flow graphs, program dependence graphs, or SSA form and matches those embeddings to embeddings derived from the analyzed binaries using an approximate nearest-neighbor index, yielding candidate source-code locations along with calibrated confidence values informed by similarity margins and auxiliary indicators such as constant pools, imported symbols, string similarity, and control- or data-flow fingerprints. When a remediation criterion is met and the confidence threshold is satisfied, the system initiates remediation actions such as synthesizing or recommending a source-code patch, inserting runtime guards, issuing a security advisory, deprecating a component version, or updating a software bill of materials. A project repository persists embeddings, features, scores, identification results, and remediation records keyed to package versions, and the models can employ attention-based pooling to weight functions by their contribution to component-level risk.

Non-transitory computer program products and computing systems configured to perform the foregoing operations are also described. Implementations can persist analysis artifacts, support reproducible evaluations, and interface with developer workflows, security operations dashboards, and compliance systems to ensure that risk assessments and mitigations are traceable across software versions and release pipelines

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a process for characterizing the contents of a software package;

FIG. 2 is a diagram for characterizing functions utilized by components of a software package;

FIG. 3 is a diagram illustrating a workflow for preprocessing components and for feature extraction therefrom;

FIG. 4 is a diagram illustrating a workflow for identifying components within a software package using machine learning as part of a vulnerability analysis;

FIG. 5 is a first process flow diagram for identifying anomalous software packages or components therein using machine learning;

FIG. 6 is a second process flow diagram for identifying anomalous software packages or components therein using machine learning;

FIG. 7 is a third process flow diagram for identifying anomalous software packages or components therein using machine learning; and

FIG. 8 is a process flow diagram illustrating a workflow for extracting a representation of the software source code, which is utilized to identify, within the original source code, the location corresponding to an anomaly detected in the binary representation; and

FIG. 9 is a process flow diagram illustrating a workflow for characterizing, triaging, and remediating software supply chain risk.

### DETAILED DESCRIPTION

The subject matter disclosed concerns machine learning techniques for detecting anomalous characteristics in software packages that may cause a computing system to behave undesirably. It further encompasses the triage of detected anomalies and, in certain embodiments, the execution of remediation actions. The machine learning models can be trained on a variety of attributes, including semantic code properties derived from a corpus of software packages.

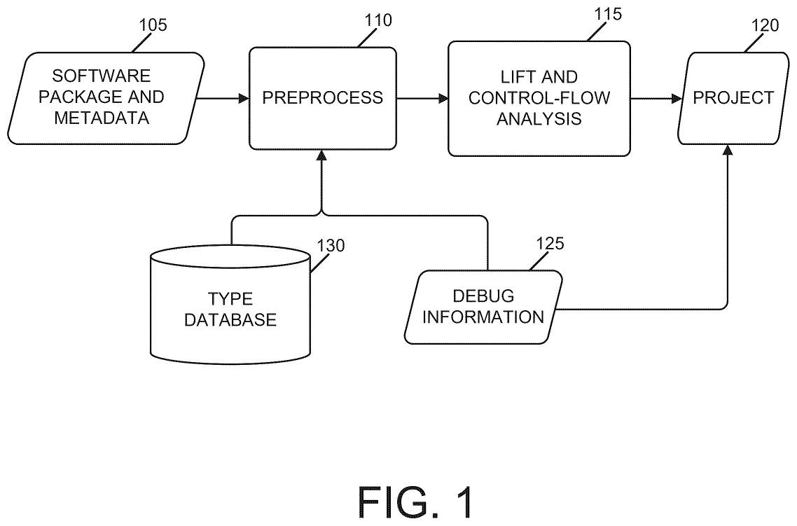

FIG. 1 is a diagram 100 illustrating the processing and analysis of a software package. In this context, a “software package” includes executables, binaries, and libraries that collectively provide coordinated functionality. At 105, the system ingests the software package together with any associated metadata. The package typically comprises multiple components that are identified and analyzed to assess potential security vulnerabilities. A software component is a unit of composition with well-defined interfaces and explicit context dependencies. Components can take many forms-such as views, models, controllers, data-access objects, services, plugins, APIs, or other modules that encapsulate related functions or data- and communicate via their published interfaces (e.g., function calls).

Metadata provides contextual information about the package and its components, including creation details, structure, purpose, and dependencies. The metadata may be embedded in the package or provided in separate files. During preprocessing at 110, the system unpacks/parses the package into its constituent components so they can be analyzed independently. Component-level metadata can be augmented from a type database 130 and/or a debugging database 125 to produce an annotated component. Such enrichment can include vendor identity, component purpose, third-party dependencies, and symbol information.

The type database 130 may be implemented as a key-value, NoSQL, or graph database storing complex type information (e.g., C/C++ structures or objects). The debugging database 125 can provide symbol mappings and alerts or fixes for known issues at the function or component level.

For purposes of analysis, each component is contextualized at the package root. The package serves as the root context for all components, and results and metadata are organized and interpreted at the package level.

Once contextualized, the annotated component at 115 is lifted into an intermediate representation (IR) to enable control-flow analysis (e.g., generating a control-flow graph defining the execution order of functions within the component). IR refers to the data structures or code used by compilers or virtual machines to represent low-level machine instructions and their operational semantics. The IR can be an intermediate language tailored to analyses such as determining the execution order of statements, instructions, or function calls. An IR topology extractor reconstructs both control-flow and data-flow graphs during lifting. Lifting and control-flow extraction identify functions, basic-block boundaries, and connectivity. The resulting artifacts populate a project 120, a hierarchical representation of the package analysis. A project aggregates results across software packages and can group multiple builds or versions for improved context and search (e.g., by device type or product). Project data may be further enriched from the debugging database 125 (e.g., applying symbol information to recover function names).

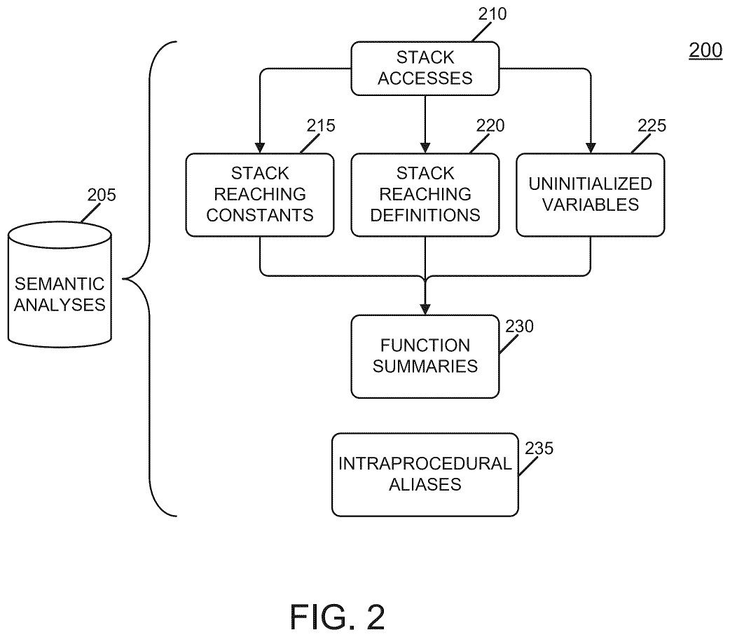

FIG. 2 is a diagram 200 showing semantic aspects of the software package captured in a semantic analysis database 205, which characterizes data flows through functions (distinct from control flow). Using the package IR at 210, the system derives attributes of function-level data flows (e.g., stack accesses). Attributes can include, at 215, whether a constant static variable resides on the stack-context useful for semantic and static analyses. Additional attributes include, at 220, stack reaching definitions (i.e., the program points at which variables are defined or killed), and, at 225, the presence of uninitialized variables, which may lead to undefined behavior. These attributes are used at 230 to generate behavioral summaries for each function. The semantic analyses 205 can also capture intraprocedural aliasing information 235 across intersecting execution paths to support deeper reasoning about the package's behavior.

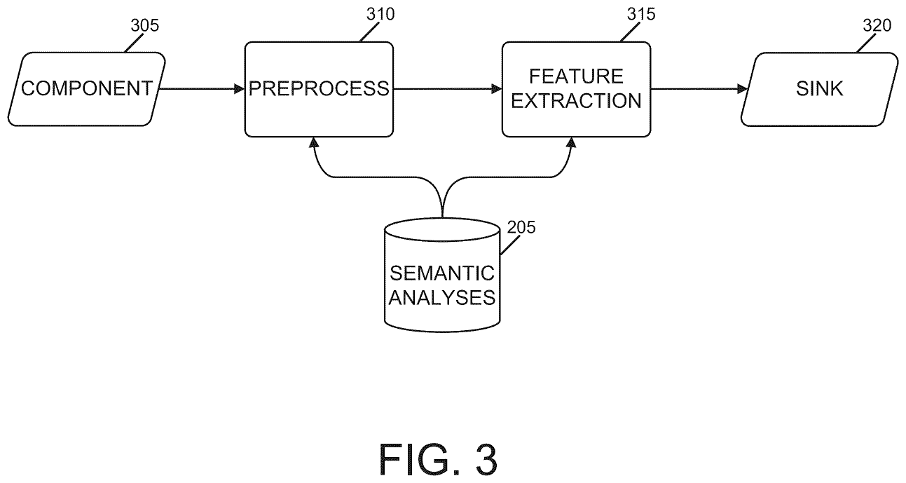

FIG. 3 is a diagram 300 depicting a workflow that consumes the semantic analyses 205. Each component 305 is preprocessed at 310 into an annotated component enriched with context about its functions from the semantic analyses database 205. Additional preprocessing at 315 extracts features that describe code semantics such as pointer usage, complex types, and other program-structure attributes-used to train machine-learning models. These features are, or are derived from, attributes of component 305 that characterize software supply-chain risk (e.g., the likelihood that a vulnerability is present). Via an intermediate sink 320, the extracted features are provided to downstream processes and applications (e.g., machine-learning models, as described below).

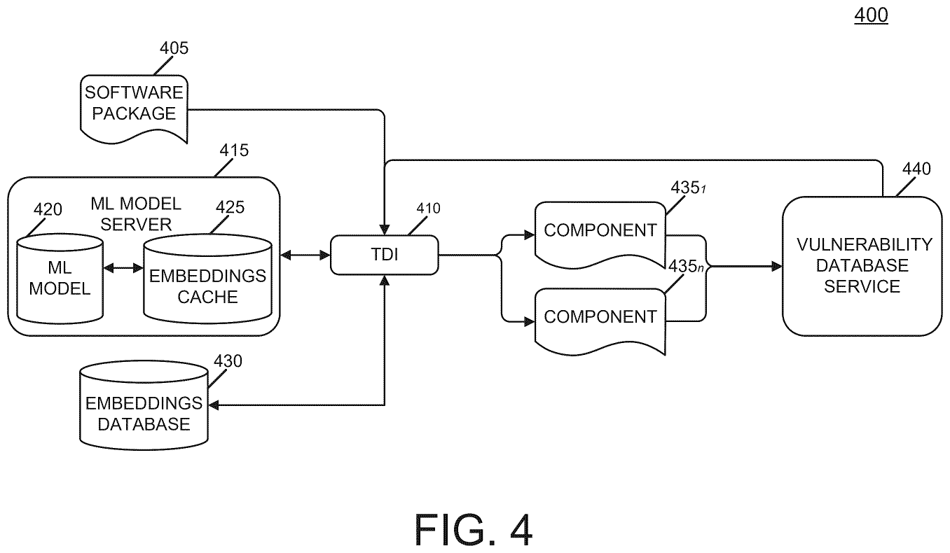

FIG. 4 is a diagram 400 showing iterative analysis of a software package 405 by a transitive dependency identifier (TDI) 410. For each component 435_{1 . . . N}, the IRs of its functions are analyzed. The TDI leverages a machine-learning model server 415 to help identify components 435_{1 . . . N} within the package 405. The model server 415 can execute one or more machine-learning models 420, including ensembles running in sequence and/or in parallel. These models are trained on datasets of decomposed packages capturing relationships among components and functions so the models learn code semantics and data-type relations rather than merely byte sequences. Training may be supervised, semi-supervised, or unsupervised. In some cases, the models operate on lower-dimensional representations (embeddings) of function IR; generated embeddings may be cached in an embeddings cache 425. The model server 415 can return identifying information for each component 435_{1 . . . N} (e.g., vendor, product name/ID, version).

In some implementations, the TDI 410 generates a function-IR embedding and queries an embeddings database 430 to determine whether the component has been previously identified. The embeddings database 430 stores embeddings of multiple functions mapped to the same component and can return identifying metadata (e.g., vendor, product, version) to the TDI 410. After component identification, the TDI 410 can query a vulnerability database service 440 to retrieve known vulnerabilities for each component. These results can drive reports and supply-chain risk scoring at the component or package level.

The machine-learning models 420 can include: (i) graph-embedding models (e.g., node2vec, DeepWalk); (ii) IR-to-vector (IR2V) models using fastText-like classification with normalized, tokenized IR inputs; and (iii) recurrent or transformer architectures trained in Siamese configurations with triplet loss on normalized, tokenized IR. Different models can address distinct stages of the detection pipeline (e.g., detecting malicious changes, classifying them, and proposing responsive actions). Code-semantics/similarity models may use RNN, Bi-RNN, or transformer architectures trained with triplet loss; the trained encoder (e.g., RNN/Bi-RNN/transformer) serves as the embedding generator.

Graph similarity models may be any approach that yields graph embeddings (e.g., node2vec, DeepWalk). IR-to-vector embedding models can include FastText- or Word2Vec-like adaptations for IR tokens rather than natural-language tokens.

One representative training dataset includes EDK2 versions compiled with different Microsoft Visual C++ (MSVC) and GNU Compiler Collection (GCC) versions and optimization levels for AArch64, x86, and x86-64 architectures. For each function, an expression static single-assignment (SSA) IR is extracted and used to form function triplets (anchor, positive, negative) for training (e.g., for RNN-based encoders), preserving semantic properties across compilation variants.

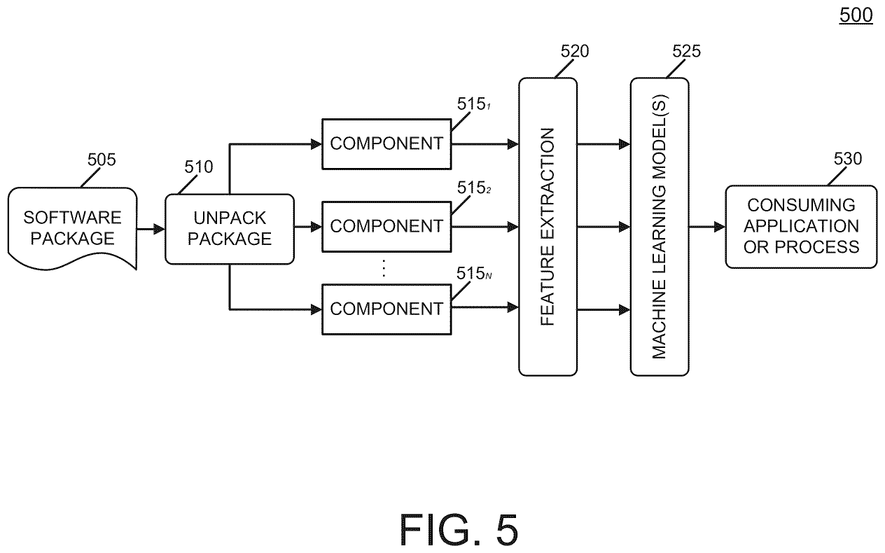

FIG. 5 is a process flow diagram 500 in which machine learning characterizes a software package (e.g., vulnerability information, publisher, version, license). A package 505 is received and, at 510, unpacked into components 515_{1 . . . N}. Unpacking can include reversing firmware compression to parse the package and extract components. From these components, at 520, features are extracted and optionally vectorized. Features may capture supply-chain attributes (e.g., component identity and provenance) and program-structure attributes (e.g., data-flow and control-flow relationships among function calls) as well as behavioral attributes (e.g., purposes of OS/firmware API calls).

The extracted features are provided to a machine-learning model 525, which in some variations is an ensemble or a multi-class classifier. Model 525 is trained to infer, from these features, the level of supply-chain risk associated with each component 515_{1 . . . N}. Model 525 may reuse one or more model types described above for models 420 and may be trained similarly.

The output of model 525 is delivered at 530 to a consuming application or process, which can compute an overall supply-chain risk score for the package 510 (or accept a score directly from model 525).

In some cases, model 525 is a multi-class classifier or ensemble configured to score multiple risk categories. For example, categories can include: open-source software control (risk from version changes), vulnerability (security risk in components), license (IP compliance risk), development (compatibility risk with an existing codebase), and support (risk from outdated/unsupported components). Classifiers may operate directly on IR/SSA features and detect/classify DFG/CFG patterns. Risk scores can be presented in a user interface, stored locally, cached in memory, and/or transmitted to remote systems.

Consuming applications/processes 530 can act on the model outputs by generating reports (e.g., populating a security/vulnerability dashboard, generating or annotating an SBOM), initiating remedial actions (e.g., isolating a component 515_{1 . . . N} or the entire package 505), and selecting mitigations based on impact classifications from an associated knowledge base.

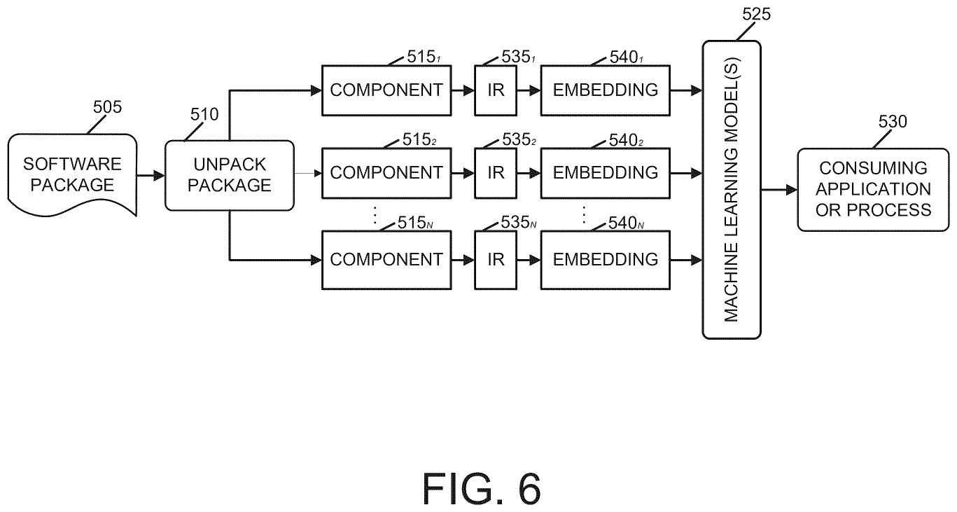

FIG. 6 is a diagram 600 illustrating a variation of FIG. 5 in which the package 505 is unpacked at 510 into components 515_{1 . . . N} and each component is lifted into a corresponding intermediate representation (IR) 535_{1 . . . N}. Lifting can employ static binary translation techniques that decode machine-code bytes into IR instructions, yielding higher-level representations suitable for analysis. The IRs 535_{1 . . . N} are then used to generate embeddings 540_{1 . . . N} via one or more dimensionality-reduction or representation-learning processes. Embeddings may be produced by word-embedding-style techniques adapted to IR tokens. Preprocessing can include tokenization and normalization. An embedding matrix is initialized to store learned vectors of a specified dimensionality. These embeddings are consumed by model(s) 525 for supply-chain risk scoring and other classifications (e.g., component identity and provenance), with outputs delivered to consuming applications/processes 530.

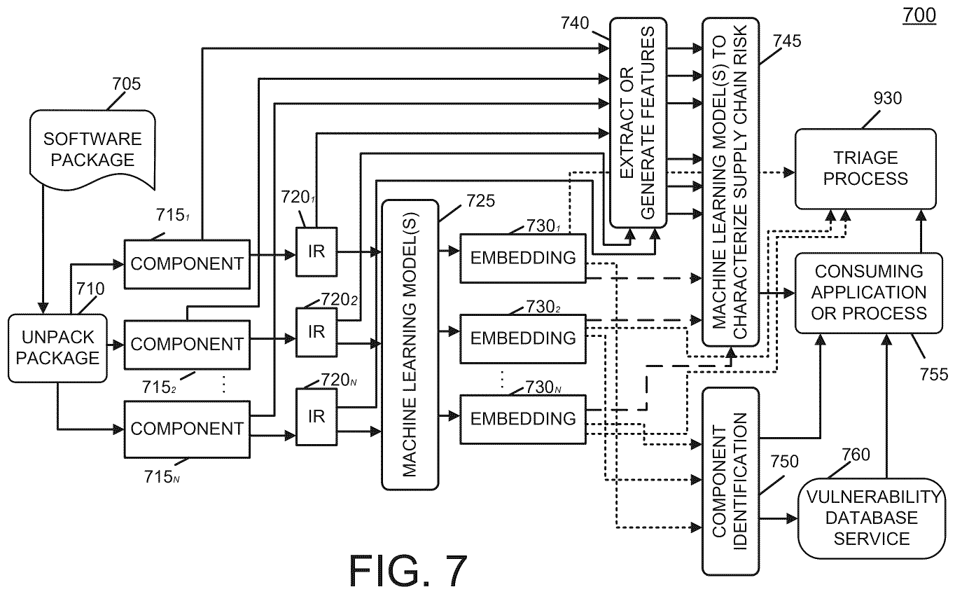

FIG. 7 is a diagram 700 illustrating another variation of FIG. 6. A package 705 is unpacked at 710 into components 715_{1 . . . N}, which are lifted into IRs 720_{1 . . . N}. The IRs 720_{1 . . . N} are then provided to one or more machine-learning models 725 to generate embeddings 730_{1 . . . N}. In some implementations, an ensemble produces multiple embeddings per IR 720_{1 . . . N}. As above, embeddings may be learned using word-embedding techniques adapted to IR tokens with appropriate tokenization and normalization.

The embeddings are consumed by a component-identification module 750 to identify components 715_{1 . . . N}. Module 750 may use trained ML classifiers on embeddings of known components and/or distance-based similarity measures. Identification results may be sent directly to a consuming application/process 755. Alternatively or additionally, a vulnerability database service 760 may be queried to retrieve known risks for the identified components, and the combined results are provided to the consuming application/process 755.

In a separate path in FIG. 7, features are extracted/generated at 740 from components 715_{1 . . . N} and IRs 720_{1 . . . N}. These features, together with embeddings 730_{1 . . . N}, are input to one or more machine-learning models 745 (e.g., models of the type described for 420) trained to characterize software supply-chain risk across multiple categories. Models 745 may be multi-class classifiers and/or ensembles that score risk at the component or package level. Their outputs are provided to the consuming application/process 755. In addition or as an alternative, identified components can be used to look up vulnerabilities via service 760. As described below, artifacts of this analysis workflow can be supplied to a triage process 930; likewise, outputs from consuming applications/processes 530 in FIGS. 5 and 6 can be provided to the triage process.

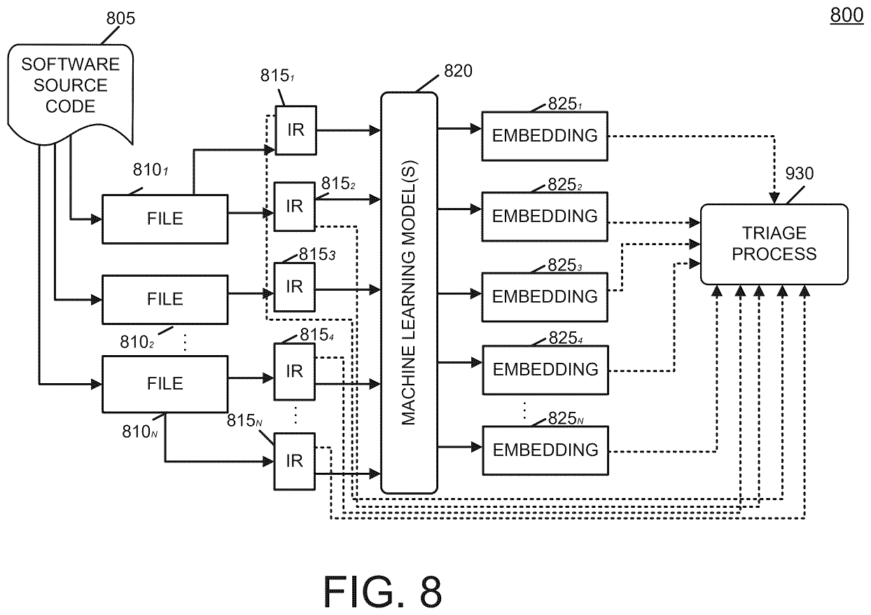

FIG. 8 is a process flow diagram 800 that depicts a workflow for extracting a representation of the software source code, which can then be used to map the anomaly identified in the binary back by the workflow in FIG. 7 to its location in the original source code. In this workflow, source code 805 is partitioned into files 810_{1 . . . N} using modularization techniques informed by logical cohesion and architectural layering. For instance, code may be separated by class or type in object-oriented languages, by discrete features or functions, or by architectural roles (e.g., models, views, controllers), with these separations corresponding to individual files.

Each file 810_{1 . . . N} is then lowered to an intermediate representation (IR) 815_{1 . . . N}. In various implementations, the lowering produces multiple program representations in parallel, including abstract syntax trees (ASTs), control-flow graphs (CFGs), dominator trees, static single-assignment (SSA) form, call graphs, and program dependence graphs (PDGs). Normalization steps can canonicalize identifier names, literal encodings, and metadata (e.g., stripping non-semantic whitespace and comments) to reduce spurious variance across versions and languages. Optional deobfuscation and inlining/outlining normalization may be applied to improve cross-compilation comparability.

The IRs are provided to a machine-learning model 820 configured to produce corresponding embeddings 825_{1 . . . N}. Model architectures can include graph neural networks (GNNs) over CFG/PDG structures, tree-based transformers operating on AST tokens, or sequence transformers over SSA instruction streams. Feature vectors may incorporate opcode/AST token vocabularies, data- and control-dependence edges, type information, string/constant pools, imported symbol signatures, and API call sequences. Embeddings can be produced at multiple granularities (e.g., basic-block-, function- and file-level) and composed hierarchically via pooling or attention mechanisms to form package-level representations. Training objectives may include contrastive learning across semantically equivalent functions compiled for different targets, triplet loss using known-vulnerable vs. patched function pairs, and masked-token/edge prediction for self-supervision. The resulting embeddings can be calibrated to a common vector space using batch or layer normalization and dimensionality reduction when needed.

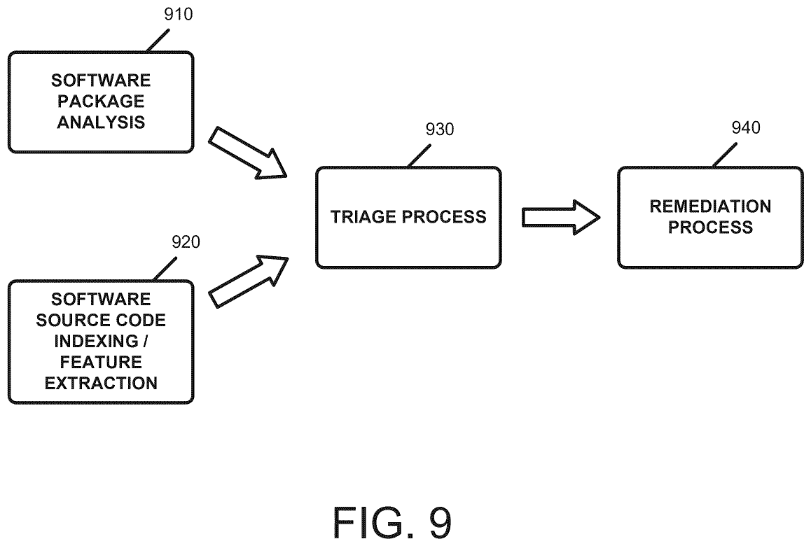

FIG. 9 is a process flow diagram (900) that presents a high-level workflow for characterizing, triaging, and remediating software supply-chain risk. After software package analysis (910) identifies an anomalous or vulnerable component—or a functionality within a component, as described with reference to FIGS. 5-7—a triage phase (930) is initiated before remediation (940). In some implementations, triage (930) incorporates the source-code analysis of FIG. 8. In triage, the system locates in the original source code the provenance of the anomalous or vulnerable functionality that produced the analyzed component (e.g., via compilation). To support provenance, the pipeline may ingest build artifacts (e.g., DWARF/PDB symbols, debug line tables, manifests), software bills of materials (SBOMs), and deterministic/reproducible-build metadata when available.

For this purpose, a second arrangement of machine-learning models—such as those referenced in FIG. 8 and likewise producing embeddings—can be employed to provide software source-code indexing and feature extraction (920). As part of triage, the embeddings generated using the workflow of FIG. 8 and those of FIGS. 5-7 should occupy the same vector space; in some cases, the same models can be used to generate both sets. One model produces embeddings from properties extracted from the original source code—for example, AST/CFG/PDG features of functions and methods—while another produces embeddings from the anomalous or vulnerable functionality observed in the binary component—for example, IR- and data-flow-level properties recovered via decompilation, lifting to SSA, and symbolic-execution traces. These two embedding sets capture the semantic characteristics of their respective inputs, enabling similarity comparisons using cosine similarity or learned metric heads. Approximate nearest-neighbor indexes (e.g., HNSW) may be used to perform scalable k-nearest searches across large codebases.

By computing the closest matches between the sets—and considering additional indicators such as constant pools, imported symbol names, string similarity, control-/data-flow fingerprints, and debug line mappings—the corresponding source-code locations for the anomalous or vulnerable functionality can be identified. Confidence scores can be derived via temperature-scaled softmax over similarity margins or via calibrated probability estimates from a logistic regressor on similarity features. Thresholds can be adaptive, for example conditioned on module size, optimization level, and obfuscation signals. When no strong matches are found (e.g., below a defined threshold or with high uncertainty), the triage process can flag potential tampering in the build pipeline (e.g., dependency confusion, compromised build steps, or injected post-link artifacts) and escalate for supply-chain forensics.

When strong matches are observed during triage 930, the entities associated with the matched embeddings serve as the basis for remediation 940. Remediation workflows can include automated patch synthesis (e.g., pattern-based transformations or neural edit models constrained by unit/regression tests), guard insertion, and policy enforcement (e.g., blocking risky APIs). Risk scoring can be aggregated at the package and dependency levels to prioritize fixes. The system can also generate and transmit a security advisory—for example, to a security operations center (SOC) dashboard—annotated with root-cause functions, exploitability indicators (e.g., input controllability, privilege boundaries), affected versions, and suggested mitigations. Post-remediation verification can re-run analysis to confirm risk reduction and update SBOM entries with corrected provenance and hashes.

Various implementations of the subject matter described herein can be realized in digital electronic circuitry, integrated circuitry, specially designed application-specific integrated circuits (ASICs), field-programmable gate arrays (FPGAs), tensor processing units (TPUs), neural processing units (NPUs), or other artificial intelligence (AI) accelerators, computer hardware, firmware, software, and/or any combination thereof. Implementations can execute on heterogeneous, distributed, and/or virtualized computing environments, including on-premises systems, cloud platforms (public, private, hybrid, multi-cloud), edge and fog nodes, mobile and embedded devices, and Internet-of-Things (IoT) endpoints. Implementations can be embodied in one or more computer programs or non-transitory computer program products executable and/or interpretable on a programmable system including at least one programmable processor (e.g., central processing unit (CPU), graphics processing unit (GPU), digital signal processor (DSP), tensor processing unit (TPU), neural processing unit (NPU)), which can be special- or general-purpose, coupled to receive data and instructions from, and to transmit data and instructions to, one or more storage systems, input devices, and output devices.

These computer programs (also referred to as programs, software, applications, services, microservices, functions, or code) include machine instructions for a programmable processor and can be implemented in high-level, procedural, object-oriented, functional, reactive, dataflow, and/or scripting languages; domain-specific languages; and/or assembly or machine languages. Programs can include hardware description languages (e.g., hardware description languages such as Verilog, VHSIC Hardware Description Language (VHDL), System Verilog) and accelerator programming models (e.g., Open Computing Language (OpenCL), SYCL). As used herein, “machine-readable medium” refers to any non-transitory computer program product, apparatus, and/or device (e.g., magnetic disks, optical disks, solid-state drives, random access memory (RAM), read-only memory (ROM), Flash, electrically erasable programmable read-only memory (EEPROM), non-volatile memory express (NVMe), three-dimensional XPoint (3D XPoint), magnetoresistive random-access memory (MRAM), phase-change random-access memory (PCRAM), and programmable logic devices (PLDs)) used to provide machine instructions and/or data to a programmable processor, including via a machine-readable signal. The term “non-transitory” as used herein excludes transitory propagating signals per se, but does not exclude information stored on non-transitory media. A “machine-readable signal” refers to any signal used to provide machine instructions and/or data to a programmable processor, including wired and wireless signals.

Storage systems can include volatile and non-volatile memory; local, network-attached, and distributed storage; file, block, and object stores; databases (relational, non-relational (NoSQL), graph, time-series), data warehouses, and data lakes. Processing and storage can be organized using virtualization and isolation technologies including hypervisors, virtual machines, containers, container orchestration systems, serverless functions, sandboxes, unikernels, and WebAssembly runtimes. Deployment and lifecycle management can utilize infrastructure-as-code, configuration management, continuous integration/continuous deployment (CI/CD) pipelines, and observability tooling (logging, metrics, tracing). Implementations can leverage security hardware and services such as trusted platform modules (TPMs), hardware security modules (HSMs), secure enclaves/trusted execution environments (Tees), cryptographic modules, and identity and access management systems; and can employ encryption in transit and at rest, attestation, code signing, and secure boot.

To provide for interaction with a user, the subject matter can be implemented on devices with displays (e.g., light-emitting diode (LED), liquid crystal display (LCD), organic light-emitting diode (OLED), electronic ink (e-ink), augmented reality (AR), virtual reality (VR), mixed reality (MR) headsets) and input mechanisms (e.g., keyboard, mouse, trackball, touchpad, touchscreen, stylus, game controller, remote control). Additional input and feedback modalities can include microphones, speakers, cameras, depth sensors, biometric sensors, haptic devices, eye tracking, gesture recognition, voice assistants, and brain-computer interfaces. Feedback can be visual, auditory, haptic, or multimodal. Implementations can support accessibility features (e.g., screen readers, captioning, alternative input).

The subject matter can be implemented in a computing system including back-end components (e.g., data servers, storage clusters, compute clusters, artificial intelligence (AI) training/inference services), middleware components (e.g., application servers, message brokers, application programming interface (API) gateways, event streams), and/or front-end components (e.g., client applications, web browsers, mobile applications (apps), thin clients), or any combination thereof. Components can be interconnected by any form or medium of digital data communication, including wired and wireless networks and protocols such as Ethernet, InfiniBand, controller area network (CAN) bus, wireless fidelity (Wi-Fi), Bluetooth/Bluetooth Low Energy (BLE), near-field communication (NFC), Zigbee, Z-Wave, long range (LoRa)/LoRa wide area network (LoRaWAN), cellular (third generation (3G), fourth generation (4G), fifth generation (5G), sixth generation (6G)), satellite, mesh networks, and the Internet. Protocols can include transmission control protocol/internet protocol (TCP/IP), user datagram protocol (UDP), quick UDP internet connections (QUIC), hypertext transfer protocol (HTTP/2-HTTP/3), WebSockets, gRPC (gRPC remote procedure calls), message queuing telemetry transport (MQTT), advanced message queuing protocol (AMQP), constrained application protocol (CoAP), and industrial protocols. Systems can employ software-defined networking, load balancing, content delivery networks, caches, and time synchronization (e.g., network time protocol (NTP), precision time protocol (PTP)). Processing can occur centrally, at the edge, on-device, or in federated and/or privacy-preserving arrangements, and can support online, offline, batch, streaming, and real-time modes.

The computing system can include clients, servers, and other interconnected components that may be distributed across various physical or virtual locations. Clients and servers can be remote from each other and typically interact through one or more communication networks, which can include local area networks, wide area networks, the Internet, or wireless and mobile networks. Clients can include desktop computers, laptops, mobile devices, web browsers, thin clients, IoT devices, or edge nodes, while servers can include physical or virtual machines, cloud-based instances, microservices, containers, or serverless functions. The client-server relationship can be established by computer programs running on the respective devices, enabling communication, data exchange, and service orchestration. Modern computing environments can support multiple tiers and roles, such as peer-to-peer, edge-to-cloud, and hybrid architectures, where clients and servers may dynamically assume different roles, participate in distributed processing, and interact with middleware, APIs, and other services. These systems can leverage load balancing, failover, replication, and autoscaling to provide robust, scalable, and resilient operation across diverse deployment models.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
receiving a software package;
unpacking the software package into a plurality of components, each component comprising a plurality of functions; lifting each function of each component into a corresponding intermediate representation (IR), the lifting comprising decoding machine code bytes corresponding to the function into higher-level IR instructions in static single-assignment (SSA) form;
generating, for each IR, using an embedding machine-learning model, an embedding that preserves code semantics and is generated directly from tokenized SSA IR, the embedding being a reduced-dimensionality representation of the corresponding IR, wherein a single component has multiple different corresponding IRs each corresponding to a different one of the plurality of functions; extracting or deriving, from each IR, IR-derived data-flow features comprising at least one of: detection of constant static variables on a stack, stack reaching definitions, uninitialized variables, and intra-procedural aliases;
inputting, on a component-by-component basis, the corresponding extracted or derived features for the component along with the corresponding embedding into at least one machine-learning model trained on code semantic properties derived from a corpus of software packages to generate a level of software supply chain risk associated with the component; providing data characterizing the generated level of software supply chain risk to a consuming application or process; and,
responsive to the generated level of software supply chain risk satisfying a remediation criterion, initiating a remediation action comprising at least one of: generating a source-code patch recommendation for a root-cause function identified for the component, inserting a runtime guard into the component, or generating a security advisory for distribution to a security operations dashboard.

2. The method of claim 1, wherein generating the embedding directly from tokenized SSA IR comprises normalizing identifiers, literal encodings, and symbol information prior to tokenization to reduce variance across compiler versions and optimization levels.

3. The method of claim 1, wherein the embedding machine-learning model comprises a Siamese network encoder trained with triplet loss over function-level SSA IR exemplars compiled with differing compilers and optimization levels, and wherein the encoder output is used as the embedding.

4. The method of claim 1, wherein the at least one machine-learning model further receives, as inputs, behavioral summaries derived from the IR, the behavioral summaries including at least one of: stack access patterns, counts of indirect calls, or detections of opaque predicates.

5. The method of claim 1, wherein initiating the remediation action further comprises ranking candidate mitigations based on an impact score computed from at least the generated level of software supply chain risk and a dependency criticality of the component within the software package.

6. The method of claim 1, further comprising aggregating component-level risk into a package-level score and persisting, with the score, the embeddings and the IR-derived data-flow features in a project repository keyed to a version of the software package.

7. The method of claim 1, further comprising, prior to initiating the remediation action, triaging the component by computing anomaly indicators based on density estimation in an embedding space and attaching at least one explanatory indicator selected from: rare API usage, high-entropy string constants, or suspicious control-flow constructs.

8. The method of claim 1, wherein the remediation action comprises automatically synthesizing a candidate patch by applying a pattern-based transformation to the source code at an identified function and validating the candidate patch against a set of regression tests.

9. The method of claim 1, wherein the remediation action comprises generating a security advisory that includes at least: an identifier of the component, the root-cause function name or address, an exploitability indicator, affected versions, and a recommended mitigation.

10. The method of claim 1, wherein inputting the extracted or derived features and the embedding into the at least one machine-learning model comprises classifying the component into a plurality of supply chain risk categories including at least a vulnerability category and a supportability category, and wherein the remediation criterion is category-specific.

11. A computer-implemented method comprising:
receiving a software package;
unpacking the software package into a plurality of components;
lifting functions of each component to SSA IR and tokenizing the SSA IR;
generating, for each function, a semantics-preserving embedding using a trained encoder that operates on tokenized SSA IR;
computing, for each component, an anomaly score by applying a one-class detector to the function embeddings of that component; and,
for each component whose anomaly score satisfies a triage threshold, identifying a source-code location corresponding to anomalous functionality by matching the embeddings to a codebase index and initiating a remediation action comprising at least one of: guard insertion at the identified source-code location or generation of a targeted patch diff.

12. The method of claim 11, wherein matching the embeddings to the codebase index comprises performing an approximate nearest-neighbor search using cosine similarity over a hierarchical navigable small world index.

13. The method of claim 11, wherein the one-class detector comprises a classifier trained on embeddings derived from a corpus of known-good components compiled for at least two different architectures.

14. The method of claim 11, further comprising computing a confidence score for the identified source-code location using a calibrated similarity margin, and deferring remediation in favor of build forensics when the confidence score fails a confidence threshold.

15. The method of claim 11, further comprising updating a software bill of materials entry for the software package to include the identified component, its anomaly score, and a reference to the initiated remediation action.

16. A computer-implemented method comprising:
receiving a software package;
unpacking the software package into components each having multiple functions;
for each function, lifting machine code bytes into an intermediate representation (IR);
extracting IR-derived data-flow features from the IR including at least uninitialized variable detections and intra-procedural alias indicators; for each function, generating a function-level embedding from tokenized SSA IR using a trained encoder;
aggregating function-level embeddings and features into a component-level vector;
classifying the component-level vector using a trained multi-class classifier to produce category-specific software supply chain risk scores including a vulnerability score; and,
when the vulnerability score exceeds a remediation threshold, generating a remediation plan specifying at least one of: source changes at identified functions, deprecation of the component version, or application of a configuration hardening policy.

17. The method of claim 16, wherein aggregating function-level embeddings comprises applying attention-based pooling that weights functions based on their contribution to the vulnerability score.

18. The method of claim 16, wherein generating the remediation plan further comprises prioritizing actions according to an exploitability metric computed from the IR-derived data-flow features including stack reaching definitions and presence of uninitialized variables.

19. The method of claim 16, further comprising applying post-remediation verification by re-running the classification on a rebuilt version of the software package and updating the category-specific software supply chain risk scores and the remediation plan status.

20. The method of claim 1, further comprising, for each component, querying a vulnerability knowledge base using an identity inferred from the embeddings and, when a known vulnerability is returned, augmenting the remediation action with a vendor-specified patch or mitigation and recording the association in a remediation log.
